(19) United States
(12) Patent Application Publication
(10) Pub. No.: US 2016/0365806 A1
(43) Pub. Date: Dec. 15, 2016

(54) REGENERATIVE CONVERTER

(71) Applicant: Mitsubishi Electric Corporation, Tokyo (JP)

(72) Inventor: Masafumi ICHIHARA, Tokyo (JP)

(73) Assignee: Mitsubishi Electric Corporation, Tokyo (JP)

(21) Appl. No.: 15/107,987

(22) PCT Filed: Jan. 19, 2015
(86) PCT No.: PCT/JP2015/051240

§ 371 Date: Jun. 24, 2016

(51) Int. Cl. H02M 7/217; H02P 29/40; H02M 1/32; H02P 27/06

(52) U.S. Cl. CPC H02M 7/217; H02P 27/06; H02P 29/40; H02M 1/32

(57) ABSTRACT

A regenerative converter includes a power conversion unit that includes a plurality of switching elements, an AC terminal connected to an AC side of the power conversion unit, a first terminal connected to one end of the power conversion unit on a DC side, a second terminal connected to the one end of the power conversion unit on the DC side via a backflow prevention element, and a third terminal connected to the other end of the power conversion unit on the DC side.

### FIELD

The present invention relates to a regenerative converter that converts power supplied from a power source to output converted power to a load and that also converts power supplied from the load to output converted power to the power source.

### BACKGROUND

A regenerative converter is a power converter that is placed between an inverter that executes variable speed control on an AC motor and an AC power source and that regenerates induced electromotive force generated at the time of deceleration of the AC motor to be fed back to the AC power source. A conventional power converter described in Patent Literature 1 has both the function of a regenerative converter and the function of an inverter and can be used as the inverter alone or the regenerative converter alone. Therefore, such a conventional power converter has high usability and can enhance productivity.

### CITATION LIST

### Patent Literature

Patent Literature 1: Japanese Patent Application Laid-open No. H7-194144

### SUMMARY

### Technical Problem

The regenerative converter is classified into two types. One type is a converter in which both a powering current supplied from an AC power source to an AC motor and a regenerative current regenerated from the AC motor to the AC power source flow through a power conversion unit of a main circuit included in the regenerative converter, and the other is a converter in which only the regenerative current flows through the power conversion unit. Hereinafter, the former converter is referred to as “total regenerative converter” and the latter is referred to as “partial regenerative converter” to simplify descriptions. While the powering current flows through the power conversion unit in the total regenerative converter, a powering-current prevention diode is provided in the partial regenerative converter to prevent the powering current from flowing through the power conversion unit. Therefore, a regenerative converter cannot be used in common as the total regenerative converter and the partial regenerative converter. In the partial regenerative converter, the capacity of the regenerative converter can be selected according to regenerative power to reduce the converter cost in a use in which the regenerative power is smaller than powering power. While having both the function of a regenerative converter and the function of an inverter, the conventional technique described in Patent Literature 1 does not have both the function of a total regenerative converter and the function of a partial regenerative converter. Therefore, the conventional technique requires a total regenerative converter that can cope with powering power even in a use in which regenerative power is small, and thus cannot address a need to further reduce the cost of the regenerative converter.

The present invention has been achieved in view of the above problem, and an object of the present invention is to provide a regenerative converter that can further reduce its cost.

### SOLUTION TO PROBLEM

In order to solve the above problem, and in order to attain the above object, a regenerative converter of the present invention includes: an AC terminal connected to an AC side of a power conversion unit; a first terminal connected to one end of the power conversion unit on a DC side; a second terminal connected to the one end of the power conversion unit on the DC side via a backflow prevention element; and a third terminal connected to other end of the power conversion unit on the DC side.

ADVANTAGEOUS EFFECTS OF INVENTION

The regenerative converter according to the present invention can achieve further reduction of its cost.

### BRIEF DESCRIPTION OF DRAWINGS

FIG. 1 is a configuration diagram of a regenerative converter according to a first embodiment of the present invention.

FIG. 2 is a configuration diagram of an inverter connected to the regenerative converter according to the first embodiment of the present invention.

FIG. 3 is a diagram illustrating an example of a connection between the regenerative converter according to the first embodiment of the present invention and the inverter when the regenerative converter is used as a total regenerative converter.

FIG. 4 is a diagram illustrating an example of a connection between the regenerative converter according to the first embodiment of the present invention and the inverter when the regenerative converter is used as a partial regenerative converter.

FIG. 5 is a configuration diagram of a regenerative converter according to a second embodiment of the present invention.

FIG. 6 is a configuration diagram of an inverter connected to the regenerative converter according to the second embodiment of the present invention.

FIG. 7 is a diagram illustrating a path of a current flowing when the inverter illustrated in FIG. 6 is connected to the regenerative converter illustrated in FIG. 1.

FIG. 8 is a diagram illustrating an example of a connection between the regenerative converter according to the second embodiment of the present invention and the inverter illustrated in FIG. 2 when the regenerative converter is used as a total regenerative converter.

FIG. 9 is a diagram illustrating an example of a connection between the regenerative converter according to the second embodiment of the present invention and the inverter illustrated in FIG. 6 when the regenerative converter is used as a total regenerative converter.

FIG. 10 is a diagram illustrating an example of a connection between the regenerative converter according to the second embodiment of the present invention and the inverter illustrated in FIG. 2 when the regenerative converter is used as a partial regenerative converter.

FIG. 11 is a diagram illustrating an example of a connection between the regenerative converter according to the second embodiment of the present invention and the inverter illustrated in FIG. 6 when the regenerative converter is used as a partial regenerative converter.

### DESCRIPTION OF EMBODIMENTS

Exemplary embodiments of a regenerative converter according to the present invention will be explained below in detail with reference to the accompanying drawings. The present invention is not limited to the embodiments.

### First Embodiment

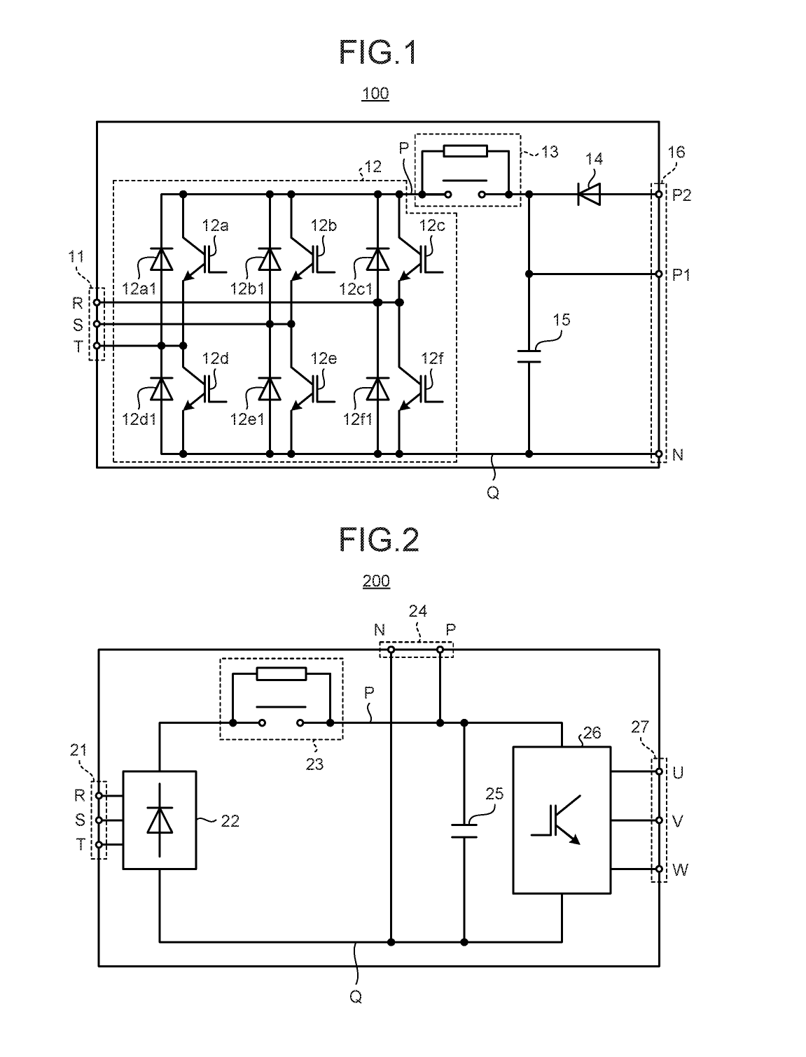

FIG. 1 is a configuration diagram of a regenerative converter according to a first embodiment of the present invention and FIG. 2 is a configuration diagram of an inverter connected to the regenerative converter according to the first embodiment. A regenerative converter 100 illustrated in FIG. 1 includes a power conversion unit 12 that is connected to an AC terminal 11 and that includes a plurality of switching elements, a DC terminal 16, an inrush-current prevention circuit 13, a powering-current prevention diode 14, and a main circuit capacitor 15. In the following descriptions, a side of the power conversion unit 12 near the AC terminal 11 is referred to as “AC side of the power conversion unit 12” and a side of the power conversion unit 12 near the DC terminal 16 is referred to as “DC side of the power conversion unit 12”.

The DC terminal 16 includes a first terminal P1 that is connected via the inrush-current prevention circuit 13 to a positive bus P which is one end of the power conversion unit 12 on the DC side and that is also connected to a positive terminal P included in a DC terminal 24 of an inverter 200 illustrated in FIG. 2, a second terminal P2 that is connected via the powering-current prevention diode 14 and the inrush-current prevention circuit 13 to the positive bus P on the DC side of the power conversion unit 12 and that is also connected to the positive terminal P included in the DC terminal 24 of the inverter 200 illustrated in FIG. 2, and a third terminal N that is connected to a negative bus Q which is the other end of the power conversion unit 12 on the DC side and that is also connected to a negative terminal N included in the DC terminal 24 of the inverter 200 illustrated in FIG. 2. The inrush-current prevention circuit 13 has one end connected to the positive bus P on the DC side of the power conversion unit 12 and the other end connected to a connection point between the powering-current prevention diode 14 and the first terminal P1. The powering-current prevention diode 14 is an example of a backflow prevention element that prevents a current flowing from the power conversion unit 12 toward the second terminal P2, that is, a powering current, and has an anode connected to the second terminal P2 and a cathode connected to the inrush-current prevention circuit 13 in the illustrated example. The main circuit capacitor 15 has one end connected to a connection point of the inrush-current prevention circuit 13, the powering-current prevention diode 14, and the first terminal P1, and the other end connected to a connection point between the negative bus Q on the DC side of the power conversion unit 12 and the third terminal N. A placement relation among the first terminal P1, the second terminal P2, the third terminal N, the powering-current prevention diode 14, and the inrush-current prevention circuit 13 is not limited to that in the illustrated example. Alternatively, a configuration in which the powering-current prevention diode 14 and the inrush-current prevention circuit 13 are connected to the negative bus Q on the DC side of the power conversion unit 12 and the direction of the powering-current prevention diode 14 is reversed can be applied.

The power conversion unit 12 includes a series circuit including a switching element 12a and a switching element 12d, a series circuit including a switching element 12b and a switching element 12e, a series circuit including a switching element 12c and a switching element 12f, a backflow prevention element 12a1 connected in parallel with the switching element 12a, a backflow prevention element 12b1 connected in parallel with the switching element 12b, a backflow prevention element 12c1 connected in parallel with the switching element 12c, a backflow prevention element 12d1 connected in parallel with the switching element 12d, a backflow prevention element 12e1 connected in parallel with the switching element 12e, and a backflow prevention element 12f1 connected in parallel with the switching element 12f. A connection point between the switching element 12c and the switching element 12f is connected to an R-phase terminal of the AC terminal 11, a connection point between the switching element 12b and the switching element 12e is connected to an S-phase terminal of the AC terminal 11, and a connection point between the switching element 12a and the switching element 12d is connected to a T-phase terminal of the AC terminal 11. A semiconductor element such as a power transistor, a power MOSFET (Metal-Oxide-Semiconductor Field-Effect Transistor), or an IGBT (Insulated Gate Bipolar Transistor) can be used as each of the switching elements 12a, 12b, 12c, 12d, 12e, and 12f. Alternatively, a wide-bandgap semiconductor such as gallium nitride or silicon carbide can be used. Because the wide-bandgap semiconductor is generally higher in the withstand voltage and the thermostability than a silicon semiconductor, the wide-bandgap semiconductor is also high in the allowable current density. Accordingly, the power conversion unit 12 can be downscaled, which enables further downscaling of the regenerative converter 100. Due to downscaling of the regenerative converter 100, the volumes of members associated with manufacturing of the regenerative converter 100 can be reduced.

The inverter 200 illustrated in FIG. 2 includes a rectification circuit 22 that includes a plurality of rectifier diodes and that is connected to an AC terminal 21, a power conversion unit 26 that includes a plurality of switching elements and that converts DC power output from the rectification circuit 22 or DC power from the regenerative converter 100 illustrated in FIG. 1 to AC power and also converts AC power input from an AC terminal 27 to DC power, an inrush-current prevention circuit 23 connected to a positive bus P between the rectification circuit 22 and the power conversion unit 26, the DC terminal 24, and a capacitor 25 that has one end connected to the positive bus P between the inrush-current prevention circuit 23 and the power conversion unit 26 and the other end connected to a negative bus Q between the rectification circuit 22 and the power conversion unit 26. The positive terminal P included in the DC terminal 24 is connected to the positive bus P between the inrush-current prevention circuit 23 and the power conversion unit 26, and the negative terminal N included in the DC terminal 24 is connected to the negative bus Q between the rectification circuit 22 and the power conversion unit 26.

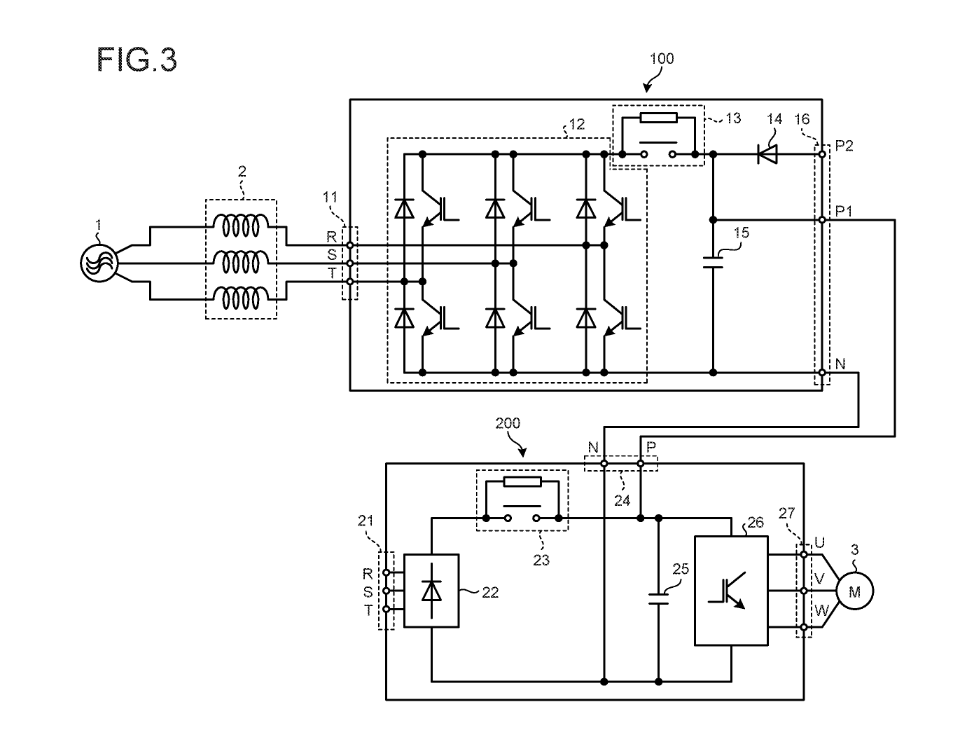

FIG. 3 is a diagram illustrating an example of a connection between the regenerative converter according to the first embodiment and the inverter when the regenerative converter is used as a total regenerative converter. When the regenerative converter 100 is used as a total regenerative converter, an AC power source 1 is connected to the AC terminal 11 of the regenerative converter 100 via a reactor 2, the positive terminal P included in the DC terminal 24 of the inverter 200 is connected to the first terminal P1 of the regenerative converter 100, and the negative terminal N included in the DC terminal 24 of the inverter 200 is connected to the third terminal N of the regenerative converter 100. As for the inverter 200, an AC motor 3 is connected to a U-phase terminal, a V-phase terminal, and a W-phase terminal included in the AC terminal 27. The AC motor 3 can be an induction motor or a synchronous motor.

Operations of the regenerative converter 100 and the inverter 200 illustrated in FIG. 3 are described below. Operations at the time of power running of the AC motor 3 are described first and operations at the time of regeneration from the AC motor 3 are described next. At the time of power running of the AC motor 3, the switching elements included in the power conversion unit 12 operate according to a switching signal output from a control circuit (not illustrated). Accordingly, AC power supplied from the AC power source 1 is converted to DC power and the converted DC power is supplied to the power conversion unit 26 via the DC terminal 16 and the DC terminal 24. The switching elements included in the power conversion unit 26 operate according to a switching signal output from the control circuit (not illustrated). Therefore, the DC power is converted to AC power in the power conversion unit 26, the AC power is supplied to the AC motor 3 via the AC terminal 27, and the AC motor 3 is driven upon receipt of supply of the AC power. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, in the power conversion unit 12, the DC power is converted to AC power and the AC power is regenerated to the AC power source 1 via the AC terminal 11 and the reactor 2.

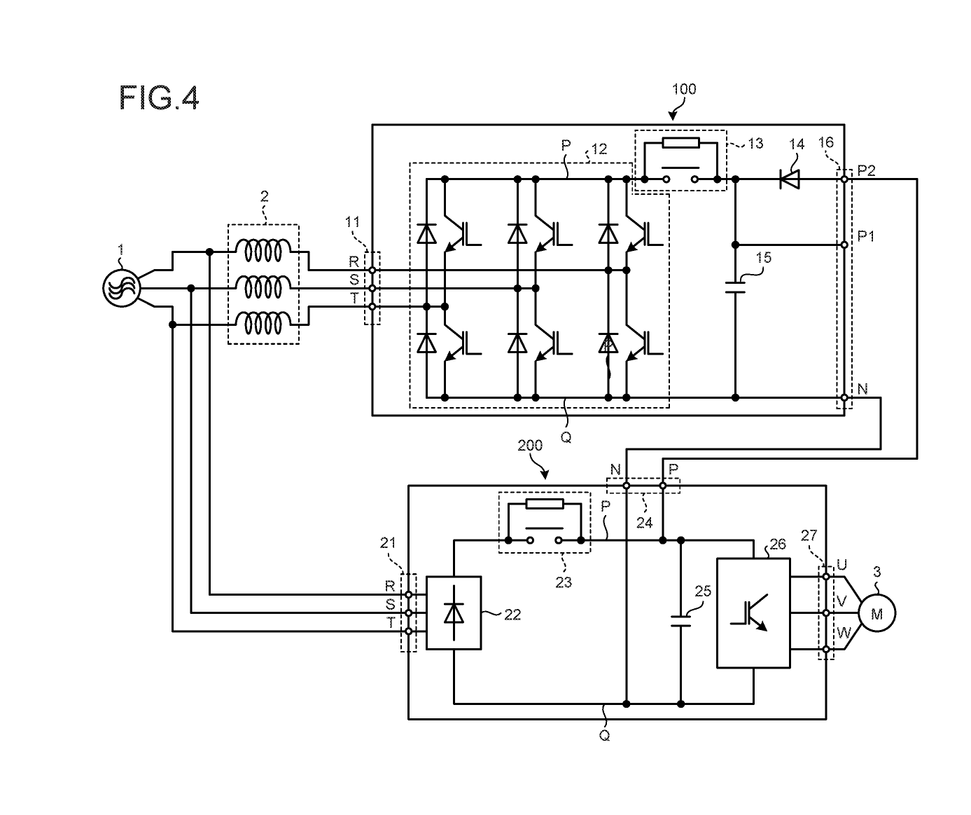

FIG. 4 is a diagram illustrating an example of a connection between the regenerative converter according to the first embodiment and the inverter when the regenerative converter is used as a partial regenerative converter.

When the regenerative converter 100 is used as a partial regenerative converter, the AC power source 1 is connected to the AC terminal 11 of the regenerative converter 100 via the reactor 2, the positive terminal P included in the DC terminal 24 of the inverter 200 is connected to the second terminal P2 of the regenerative converter 100, and the negative terminal N included in the DC terminal 24 of the inverter 200 is connected to the third terminal N of the regenerative converter 100. As for the inverter 200, the AC power source 1 is connected to the AC terminal 21, and the AC motor 3 is connected to the U-phase terminal, the V-phase terminal, and the W-phase terminal included in the AC terminal 27.

Operations of the regenerative converter 100 and the inverter 200 illustrated in FIG. 4 are described below. Operations at the time of power running of the AC motor 3 are described first and operations at the time of regeneration from the AC motor 3 are described next. At the time of power running of the AC motor 3, AC power supplied from the AC power source 1 is converted to DC power by the rectifier diodes included in the rectification circuit 22, and the converted DC power is supplied to the power conversion unit 26. The switching elements included in the power conversion unit 26 operate according to a switching signal output from the control circuit (not illustrated). Accordingly, the power conversion unit 26 converts the DC power to AC power, the AC power is supplied to the AC motor 3 via the AC terminal 27, and the AC motor 3 is driven upon receipt of supply of the AC power. At that time, the diode 14 prevents power from flowing through the converter 12. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, the DC power is converted to AC power in the power conversion unit 12, and the AC power is regenerated to the AC power source 1 via the AC terminal 11 and the reactor 2.

As described above, the regenerative converter 100 according to the first embodiment functions as a partial regenerative converter when the DC terminal 24 of the inverter 200 is connected to the second terminal P2 and the third terminal N, and the regenerative converter 100 functions as a total regenerative converter when the DC terminal 24 of the inverter 200 is connected to the first terminal P1 and the third terminal N. While a powering current flows through the power conversion unit in the total regenerative converter as described above, the partial regenerative converter needs to be configured to prevent a powering current from flowing through the power conversion unit. Therefore, the conventional technique cannot be used in common as the total regenerative converter and the partial regenerative converter. However, the regenerative converter 100 according to the first embodiment has the DC terminal 16 including the first terminal P1, the second terminal P2, and the third terminal N and can operate as either the partial regenerative converter or the total regenerative converter by switching a connection of the DC terminal 16.

The partial regenerative converter is suitable for a case where a load driven by an AC motor is a load having a large mechanical loss, such as a belt conveyer or a pump. On the other hand, the total regenerative converter is suitable for a case where a load driven by an AC motor is a load having a small mechanical loss, such as an automobile or a train. To describe specifically, a load having a large mechanical loss loses most of regenerative power as a mechanical loss and therefore regenerative power supplied to a regenerative converter is less than that in a case of using a load having a small mechanical loss. In the combination of the regenerative converter 100 and the inverter 200 illustrated in FIG. 4, powering power can be imposed on the inverter 200 and thus the powering capacity of the inverter 200 and the regenerative capacity of the regenerative converter 100 meets the following relation: “power capacity”>>“regenerative capacity”. Accordingly, in the combination of the regenerative converter 100 and the inverter 200 illustrated in FIG. 4, a relation between the inverter capacity at the time of regeneration and the converter capacity at the time of power running can be set as follows: “inverter capacity”>>“converter capacity”. Therefore, the partial regenerative converter can be formed in a smaller size and with a smaller cost than the total regenerative converter.

### Second Embodiment

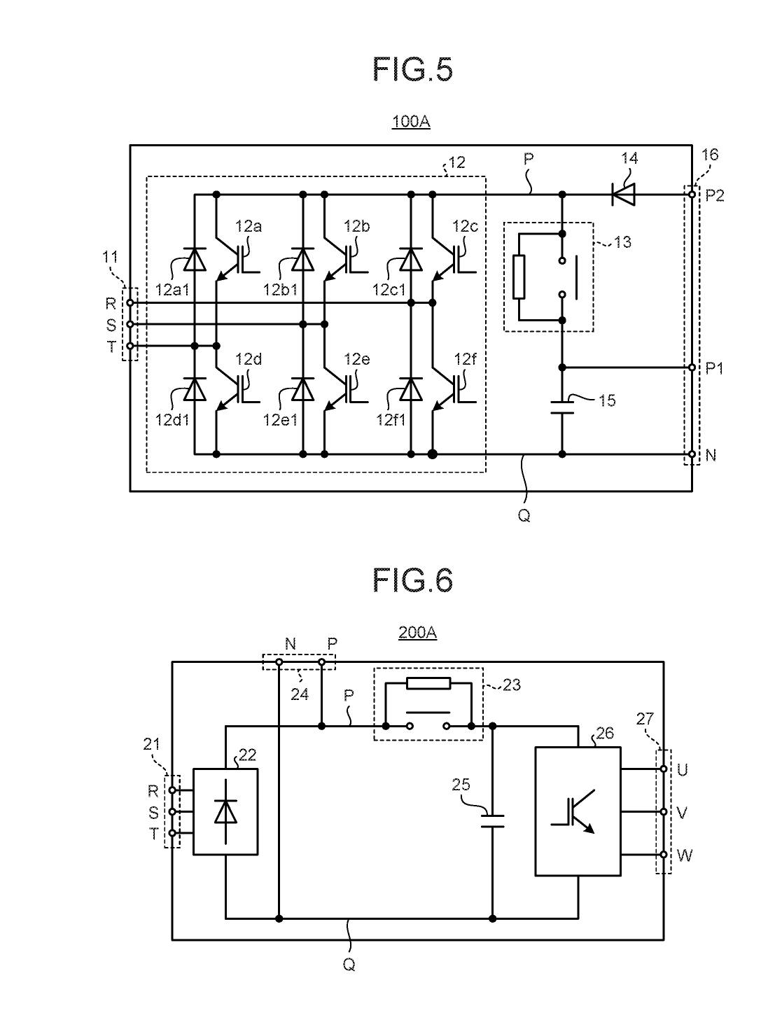

FIG. 5 is a configuration diagram of a regenerative converter according to a second embodiment of the present invention. In the second embodiment, elements identical to those of the first embodiment are denoted with like reference signs, and descriptions thereof will be omitted and only elements different from the first embodiment are described. A regenerative converter 100A illustrated in FIG. 5 includes the power conversion unit 12, the inrush-current prevention circuit 13, the powering-current prevention diode 14, the main circuit capacitor 15, and the DC terminal 16 similarly to the regenerative converter 100 illustrated in FIG. 1. A difference from the regenerative converter 100 illustrated in FIG. 1 is the position of the inrush-current prevention circuit 13 and the position of the main circuit capacitor 15. In the regenerative converter 100A illustrated in FIG. 5, the inrush-current prevention circuit 13 has an end connected to a connection point between the positive bus P on the DC side of the power conversion unit 12 and the powering-current prevention diode 14, and the other end connected to a connection point between the first terminal P1 and the main circuit capacitor 15. The main circuit capacitor 15 has one end connected to a connection point between the inrush-current prevention circuit 13 and the first terminal P1 and the other end connected to a connection point between the negative bus Q on the DC side of the power conversion unit 12 and the third terminal N.

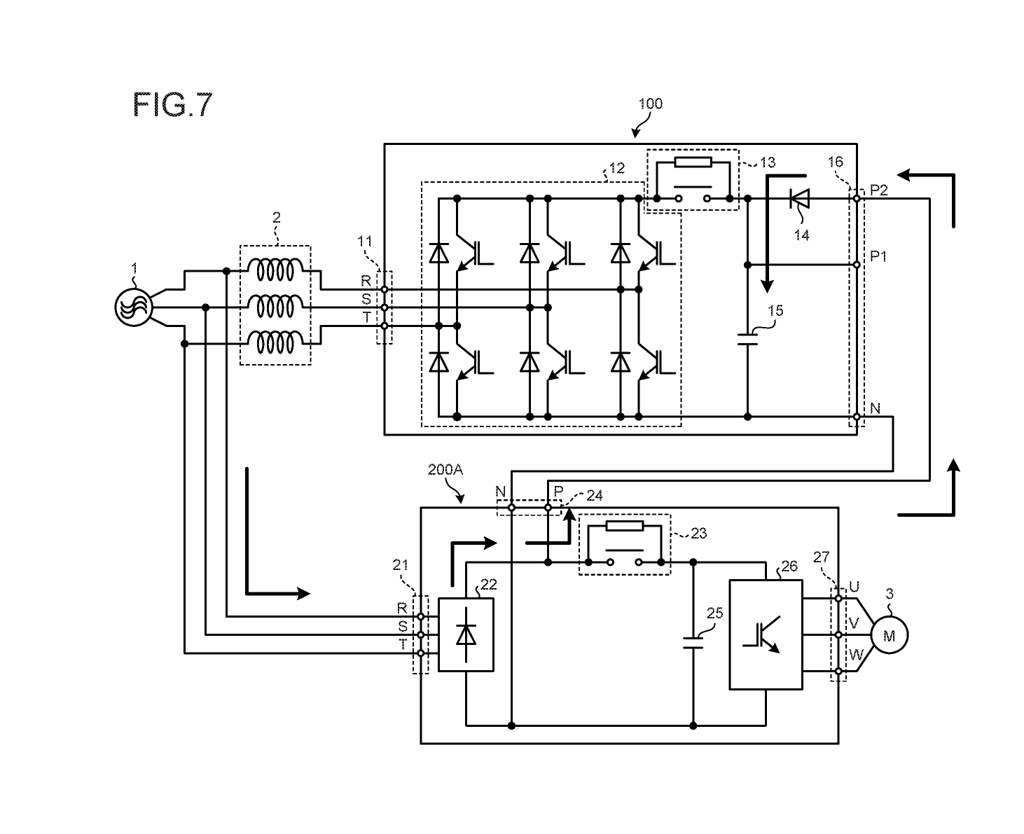

FIG. 6 is a configuration diagram of an inverter connected to the regenerative converter according to the second embodiment and FIG. 7 is a diagram illustrating a path of a current flowing when the inverter illustrated in FIG. 6 is connected to the regenerative converter illustrated in FIG. 1. An inverter 200A illustrated in FIG. 6 includes the rectification circuit 22, the power conversion unit 26, the inrush-current prevention circuit 23, the DC terminal 24, and the capacitor 25 similarly to the inverter 200 illustrated in FIG. 2. A difference from the inverter 200 illustrated in FIG. 2 is the connection position of the DC terminal 24. In the inverter 200A illustrated in FIG. 6, the positive terminal P included in the DC terminal 24 is connected to the positive bus P between the inrush-current prevention circuit 23 and the rectification circuit 22.

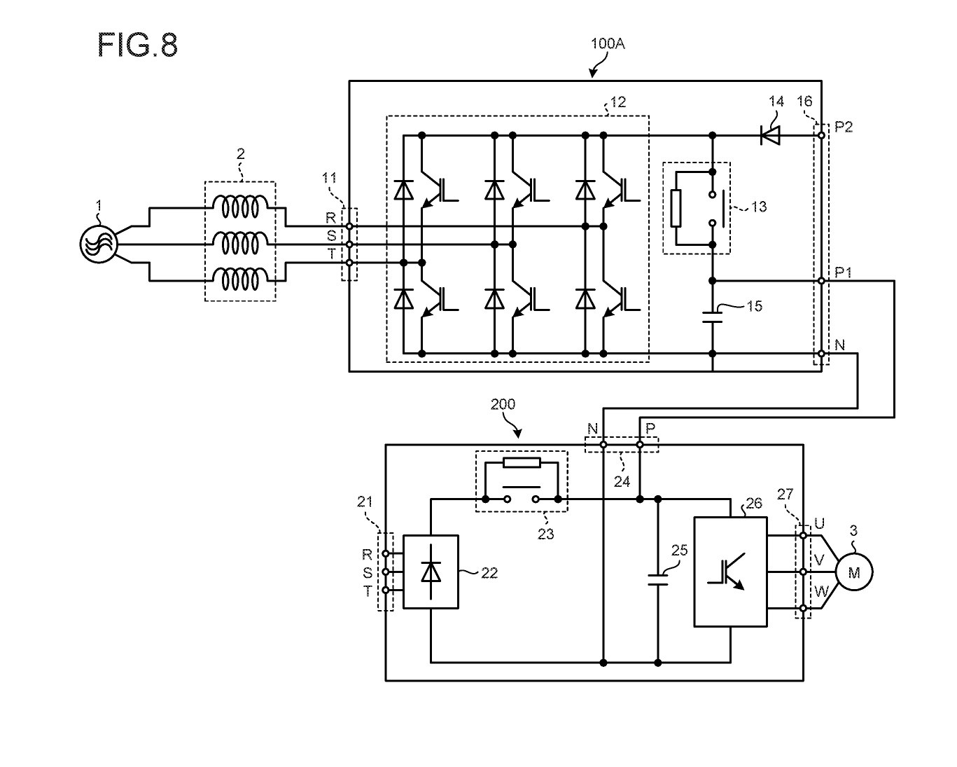

FIG. 7 illustrates an example in which the regenerative converter 100 illustrated in FIG. 1 is connected to the inverter 200A illustrated in FIG. 6. A combination of the regenerative converter 100 and the inverter 200A illustrated in FIG. 7 is a connection configuration in a case where the regenerative converter 100 is used as a partial regenerative converter. According to the connection example in FIG. 7, the positive terminal P included in the DC terminal 24 of the inverter 200A is connected to the second terminal P2 included in the DC terminal 16 of the regenerative converter 100, and the negative terminal N included in the DC terminal 24 of the inverter 200A is connected to the third terminal N included in the DC terminal 16 of the regenerative converter 100. In the connection example in FIG. 7, the AC terminal 21, the rectification circuit 22, the DC terminal 24, the powering-current prevention diode 14, and the main circuit capacitor 15 are brought to a connected state at the time of power activation, and a current flows through a path indicated by solid arrows. That is, the current flows without passing through the inrush-current prevention circuit and thus the main circuit capacitor 15 is connected directly to the AC power source 1 to cause a short-circuit current to flow. In the regenerative converter 100A illustrated in FIG. 5, the inrush-current prevention circuit 13 is connected between the connection point between the positive bus P on the DC side of the power conversion unit 12 and the powering-current prevention diode 14 and the connection point between the first terminal P1 and the main circuit capacitor 15. Accordingly, whichever of the inverter 200 illustrated in FIG. 2 and the inverter 200A illustrated in FIG. 6 is connected to the regenerative converter 100A illustrated in FIG. 5, occurrence of a short-circuit current can be prevented. This is described specifically with reference to FIGS. 8 to 11.

FIG. 8 is a diagram illustrating an example of a connection between the regenerative converter according to the second embodiment and the inverter illustrated in FIG. 2 when the regenerative converter is used as a total regenerative converter. When the regenerative converter 100A is used as a total regenerative converter, the AC power source 1 is connected to the AC terminal 11 of the regenerative converter 100A via the reactor 2, the positive terminal P included in the DC terminal 24 of the inverter 200 is connected to the first terminal P1 of the regenerative converter 100A, and the negative terminal N included in the DC terminal 24 of the inverter 200 is connected to the third terminal N of the regenerative converter 100A. As for the inverter 200, the AC motor 3 is connected to the U-phase terminal, the V-phase terminal, and the W-phase terminal included in the AC terminal 27.

Operations of the regenerative converter 100A and the inverter 200 illustrated in FIG. 8 are described below. Operations at the time of power running of the AC motor 3 are described first and operations at the time of regeneration from the AC motor 3 are described next. At the time of power running of the AC motor 3, the switching elements included in the power conversion unit 12 operate according to a switching signal output from a control circuit (not illustrated). Accordingly, AC power supplied from the AC power source 1 is converted to DC power and the converted DC power is supplied to the power conversion unit 26 via the DC terminal 16 and the DC terminal 24. The switching elements included in the power conversion unit 26 operate according to a switching signal output from the control circuit (not illustrated). Therefore, the DC power is converted to AC power in the power conversion unit 26, the AC power is supplied to the AC motor 3 via the AC terminal 27, and the AC motor 3 is driven upon receipt of supply of the AC power. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, in the power conversion unit 12, the DC power is converted to AC power and the AC power is regenerated to the AC power source 1 via the AC terminal 11 and the reactor 2.

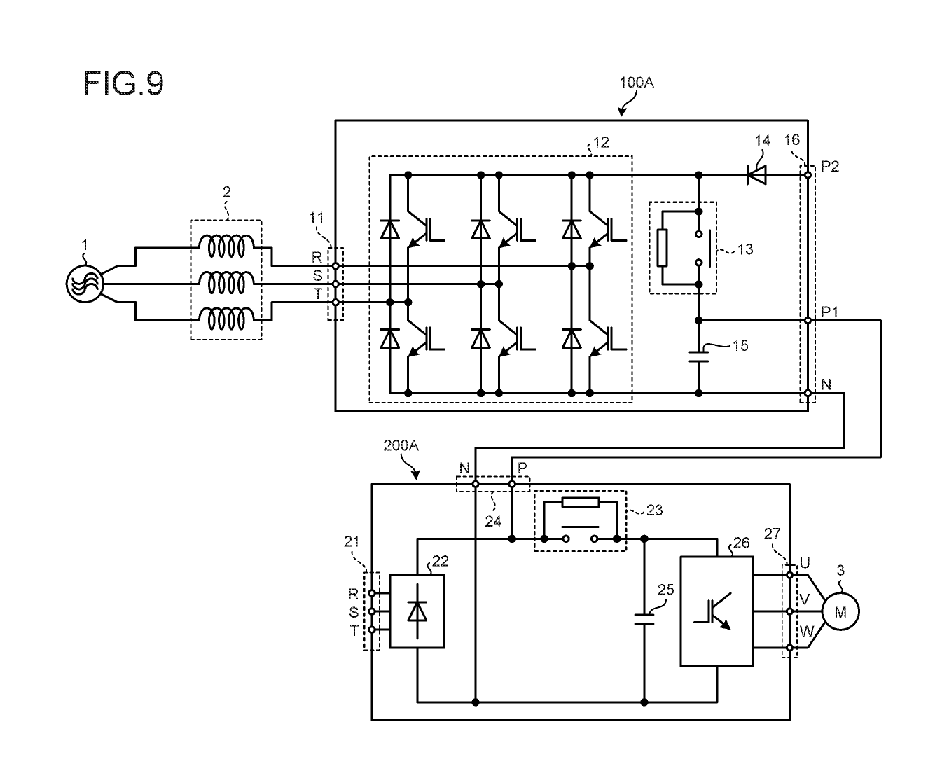

FIG. 9 is a diagram illustrating an example of a connection between the regenerative converter according to the second embodiment and the inverter illustrated in FIG. 6 when the regenerative converter is used as a total regenerative converter. When the regenerative converter 100A is used as a total regenerative converter, the AC power source 1 is connected to the AC terminal 11 of the regenerative converter 100A via the reactor 2, the positive terminal P included in the DC terminal 24 of the inverter 200A is connected to the first terminal P1 of the regenerative converter 100A, and the negative terminal N included in the DC terminal 24 of the inverter 200A is connected to the third terminal N of the regenerative converter 100A.

Operations of the regenerative converter 100A and the inverter 200A illustrated in FIG. 9 are described below. At the time of power running of the AC motor 3, the switching elements included in the power conversion unit 12 operate according to a switching signal output from a control circuit (not illustrated), so that AC power supplied from the AC power source 1 is converted to DC power and the converted DC power is supplied to the power conversion unit 26 via the DC terminal 16 and the DC terminal 24. The switching elements included in the power conversion unit 26 operate according to a switching signal output from the control circuit (not illustrated). Accordingly, the DC power is converted to AC power in the power conversion unit 26, the AC power is supplied to the AC motor 3 via the AC terminal 27, and the AC motor 3 is driven upon receipt of supply of the AC power. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, the DC power is converted to AC power in the power conversion unit 12, and the AC power is regenerated to the AC power source 1 via the AC terminal 11 and the reactor 2.

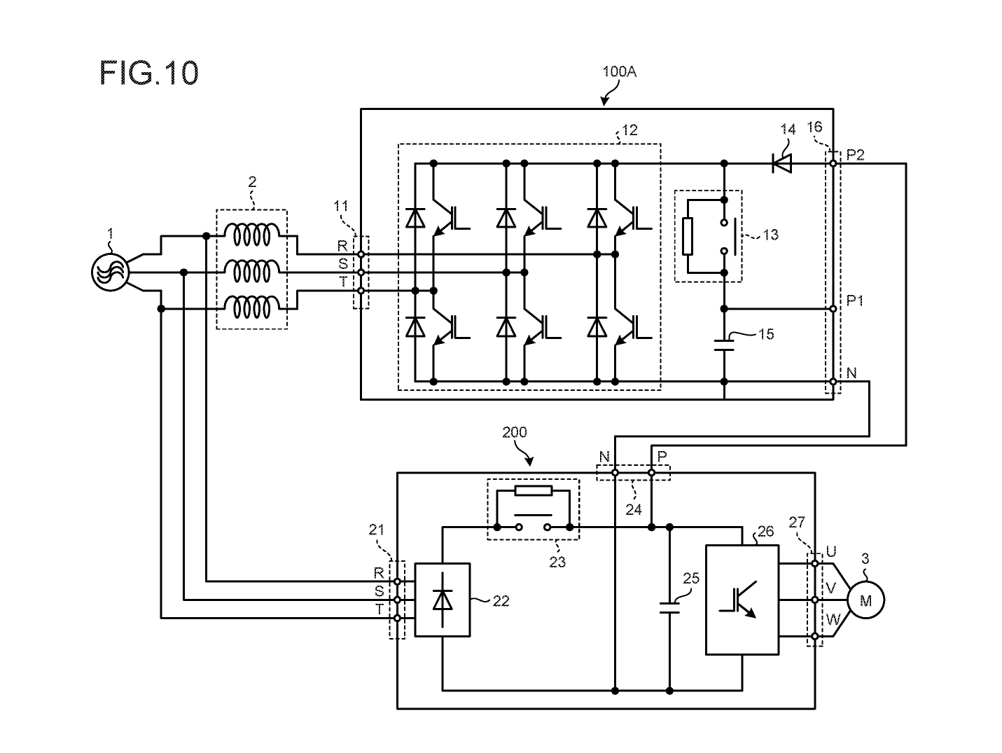

FIG. 10 is a diagram illustrating an example of a connection between the regenerative converter according to the second embodiment and the inverter illustrated in FIG. 2 when the regenerative converter is used as a partial regenerative converter. When the regenerative converter 100A is used as a partial regenerative converter, the AC power source 1 is connected to the AC terminal 11 of the regenerative converter 100A via the reactor 2, the positive terminal P included in the DC terminal 24 of the inverter 200 is connected to the second terminal P2 of the regenerative converter 100A, and the negative terminal N included in the DC terminal 24 of the inverter 200 is connected to the third terminal N of the regenerative converter 100A. As for the inverter 200, the AC power source 1 is connected to the AC terminal 21, and the AC motor 3 is connected the U-phase terminal, the V-phase terminal, and the W-phase terminal included in the AC terminal 27.

Operations of the regenerative converter 100A and the inverter 200 illustrated in FIG. 10 are described below. At the time of power running of the AC motor 3, the rectifier diodes included in the rectification circuit 22 convert AC power supplied from the AC power source 1 to DC power and the converted DC power is supplied to the power conversion unit 26. The switching elements included in the power conversion unit 26 operate according to a switching signal output from a control circuit (not illustrated). Accordingly, the DC power is converted to AC power in the power conversion unit 26, the AC power is supplied to the AC motor 3 via the AC terminal 27, and the AC motor 3 is driven upon receipt of supply of the AC power. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, the DC power is converted to AC power in the power conversion unit 12, and the AC power is regenerated to the AC power source 1 via the AC terminal 11 and the reactor 2.

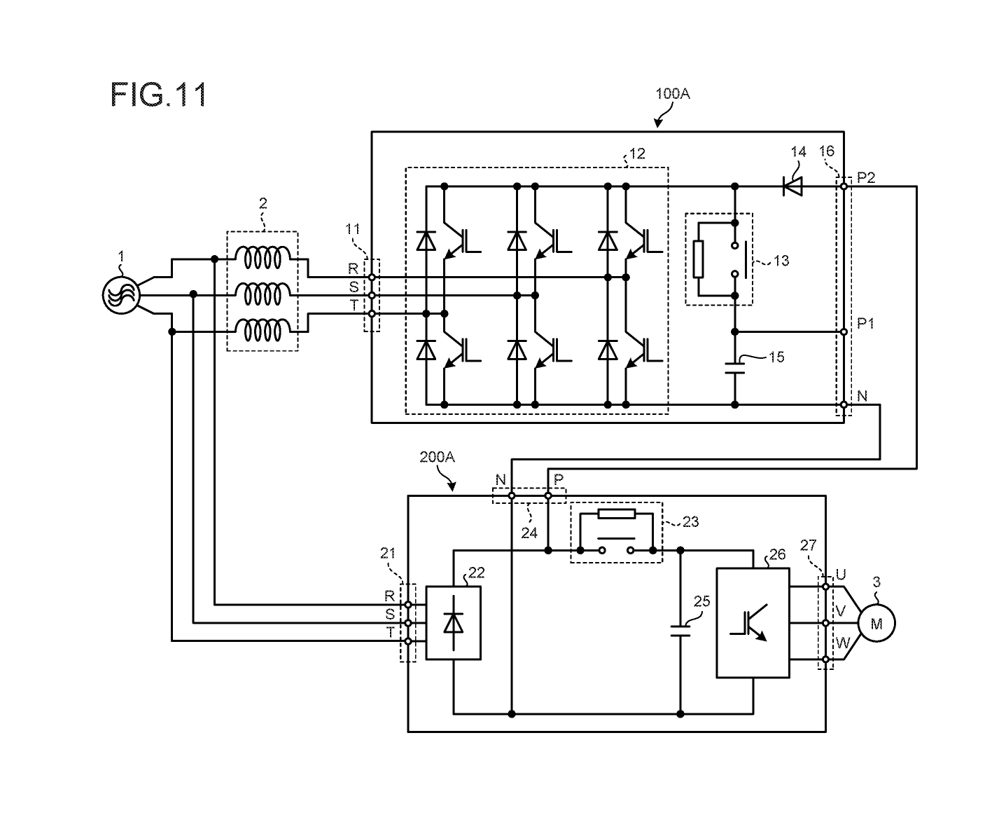

FIG. 11 is a diagram illustrating an example of a connection between the regenerative converter according to the second embodiment and the inverter illustrated in FIG. 6 when the regenerative converter is used as a partial regenerative converter. When the regenerative converter 100A is used as a partial regenerative converter, the AC power source 1 is connected to the AC terminal 11 of the regenerative converter 100A via the reactor 2, the positive terminal P included in the DC terminal 24 of the inverter 200A is connected to the second terminal P2 of the regenerative converter 100A, and the negative terminal N included in the DC terminal 24 of the inverter 200A is connected to the third terminal N of the regenerative converter 100A. As for the inverter 200A, the AC power source 1 is connected to the AC terminal 21 and the AC motor 3 is connected to the U-phase terminal, the V-phase terminal, and the W-phase terminal included in the AC terminal 27.

Operations of the regenerative converter 100A and the inverter 200A illustrated in FIG. 11 are described below. At the time of power running of the AC motor 3, the rectifier diodes included in the rectification circuit 22 convert AC power supplied from the AC power source 1 to DC power and the converted DC power is supplied to the power conversion unit 26. The switching elements included in the power conversion unit 26 operate according to a switching signal output from a control circuit (not illustrated). Accordingly, the DC power is converted to AC power in the power conversion unit 26, the AC power is supplied to the AC motor 3 via the AC terminal 27, and the AC motor 3 is driven upon receipt of supply of the AC power. At the time of regeneration from the AC motor 3, the switching elements included in the power conversion unit 26 operate according to a switching signal output from the control circuit (not illustrated), so that AC power supplied from the AC motor 3 is converted to DC power and the converted DC power is supplied to the power conversion unit 12 via the DC terminal 24 and the DC terminal 16. The switching elements included in the power conversion unit 12 operate according to a switching signal output from the control circuit (not illustrated). Accordingly, the DC power is converted to AC power in the power conversion unit 12, and the AC power is regenerated to the AC power source 1 via the AC terminal 11 and the reactor 2.

As described above, the regenerative converters 100 and 100A according to the first and second embodiments each include the AC terminal connected to the AC side of the power conversion unit, the first terminal connected to one end of the power conversion unit on the DC side, the second terminal connected to the one end of the power conversion unit on the DC side via the backflow prevention element, and the third terminal connected to the other end of the power conversion unit on the DC side. Due to this configuration, the regenerative converters 100 and 100A each can provide the function of a total regenerative converter and the function of a partial regenerative converter by switching a connection of the DC terminal including the first terminal P1, the second terminal P2, and the third terminal N. Therefore, regenerative converters having the respective functions do not need to be manufactured individually and the cost thereof can be further reduced.

The regenerative converter 100A according to the second embodiment has the second terminal and the third terminal connected to the DC terminal of the inverter 200A having the rectification circuit, the power conversion unit that converts DC power from the rectification circuit to AC power, the inrush-current prevention circuit placed between the power conversion unit and the rectification circuit, and the DC terminal placed between the inrush-current prevention circuit and the rectification circuit. Due to this configuration, even when the inverter 200A is connected to the regenerative converter 100A as illustrated in FIG. 11, a short-circuit current at the time of power activation is blocked by the inrush-current prevention circuit 13 in the regenerative converter 100A. As a result, the regenerative converter 100A according to the second embodiment can provide an enhanced quality in addition to the effect of the first embodiment.

The configuration described in the above embodiments is only an example of the contents of the present invention. The configuration can be combined with other well-known techniques, and a part of the configuration can be omitted or modified without departing from the scope of the invention.

### Reference Signs List

1 AC power source, 2 reactor, 3 AC motor, 11 AC terminal, 12 power conversion unit, 12a, 12b, 12c, 12d, 12e, 12f switching element, 12a1, 12b1, 12c1, 12d1, 12e1, 12f1 backflow prevention element, 13 inrush-current prevention circuit, 14 powering-current prevention diode, main circuit capacitor, 16 DC terminal, 21 AC terminal, 22 rectification circuit, 23 inrush-current prevention circuit, 24 DC terminal, 25 capacitor, 26 power conversion unit, 27 AC terminal, 100, 100A regenerative converter, 200, 200A inverter.

1. A regenerative converter comprising:
a power conversion unit;
an AC terminal connected to an AC side of the power conversion unit;
a first terminal connected to one end of the power conversion unit on a DC side;
a second terminal connected to the one end of the power conversion unit on the DC side via a backflow prevention element; and
a third terminal connected to other end of the power conversion unit on the DC side.

2. The regenerative converter according to claim 1, including an inrush-current prevention circuit that has one end connected to the one end of the power conversion unit on the DC side, and other end connected to a connection point between the backflow prevention element and the first terminal.

3. The regenerative converter according to claim 1, including an inrush-current prevention circuit that has one end connected to a connection point between the one end of the power conversion unit on the DC side and the backflow prevention element, and other end connected to the first terminal.

4. The regenerative converter according to claim 3, wherein the second terminal and the third terminal are connected to a DC terminal of an inverter including a rectification circuit, a power conversion unit that converts DC power from the rectification circuit to AC power, an inrush-current prevention circuit that is placed between the power conversion unit and the rectification circuit, and the DC terminal placed between the inrush-current prevention circuit and the rectification circuit.
